(19) United States
(12) Patent Application Publication
(10) Pub. No.: US 2004/0195778 A1
(43) Pub. Date: Oct. 7, 2004

(54) Resilient mount and shaft seal for motor

(76) Inventors: Oscar M. Smith, Port Stanley (CA); Daniel J. Lacourciere, London (CA); Gordon H. Olmstead, London (CA)

Correspondence Address: WILLIAM R. GUSTAVSON, SUITE 1185, 9330 LBJ FRWY., DALLAS, TX, 75243, US

(21) Appl. No.: 10/407,813

(22) Filed: Apr. 4, 2003

(51) Int. Cl. F16J 15/32

(52) U.S. Cl. 277/549

(57) ABSTRACT

A unitary elastomeric combined mount and shaft seal (26) acts to both mount the outer race (36) of a bearing (16) in the motor housing (28) and seal against the motor shaft (14). The combined mount and shaft seal (26) includes a first bearing mount portion (30) compressed between the motor housing (28) and bearing (16) to form the mount and a second shaft seal portion (38) including seal lips (40, 42) sealing against the motor shaft (14).

### BACKGROUND OF THE INVENTION

The entry of contaminants, such as liquids(including water, gasolene, coolant, diesel, etc.), dirt and debris, into the interior of a motor can shorten the life of the motor, reducing reliability and requiring expensive repair. While seals for motors are known, they are often complex and multicomponent assemblies which add considerable expense and complexity to the motor.

A need exists for a reliable and inexpensive system to prevent the entry of contaminants into a motor.

### SUMMARY OF THE INVENTION

In accordance with a one aspect of the present invention, a device is provided for use with a housing and a shaft mounting a bearing thereon, with the shaft extending through the housing. The device includes a unitary elastomeric member having a first portion mounting the outer race of the bearing in the housing and forming a seal between the bearing and the housing and a second portion sealing against the shaft. In accordance with another aspect of the invention, the housing is a housing for a fractional horsepower motor and the shaft is the motor shaft thereof.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1 is a cross-sectional view of a motor illustrating use of a combined mount and shaft seal forming a first embodiment of the present invention;

FIG. 2 is a detail view of the combined mount and shaft seal; and

FIG. 3 is a detail view of the shaft seal lips of the combined mount and shaft seal.

### DETAILED DESCRIPTION

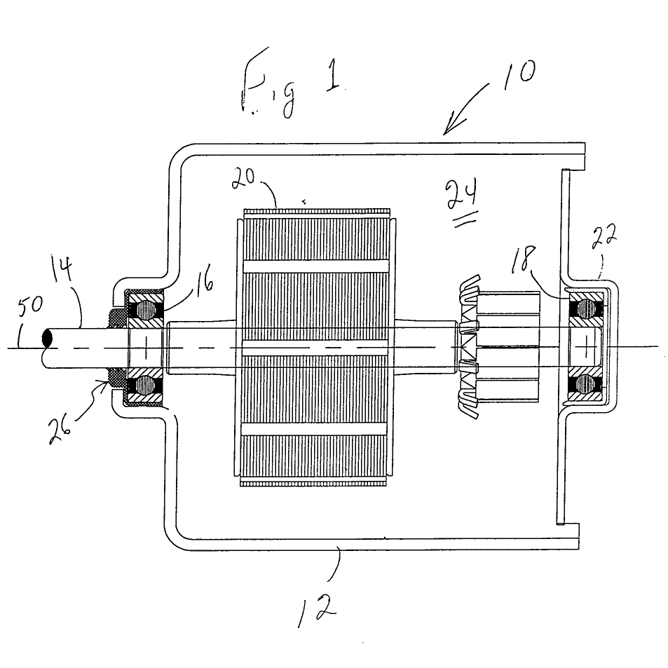

With reference now to the accompanying drawings, wherein like or corresponding parts are designated by the same reference numerals, FIG. 1 illustrates a motor 10 having a casing 12 supporting a rotating motor shaft 14. Motor shaft 14 is supported at the ends of the casing 12 by bearings 16 and 18 for rotation about the rotational axis 50 of motor shaft 14. Motor shaft 14 mounts the armature 20 of the motor in the conventional manner. The end of the casing 12 mounting bearing 18 is enclosed by a cover 22 that prevents contaminants from entering the interior 24 of the motor 10 at that end. A unitary elastomeric combined mount and shaft seal 26 at the opposite end of the motor 10 provides a mount for the bearing 16 and a seal against rotating motor shaft 14. The combined mount and shaft seal 26 prevents contaminants from entering the interior 24 of the motor 10 at that end of the motor as will be described in greater detail hereinafter. If the motor has a double shaft extension, with the motor shaft extending out of the motor at both ends of the motor(as compared to the single shaft extension motor 10), a combined mount and shaft seal 26 can be used at each end of the motor to seal both exposed ends.

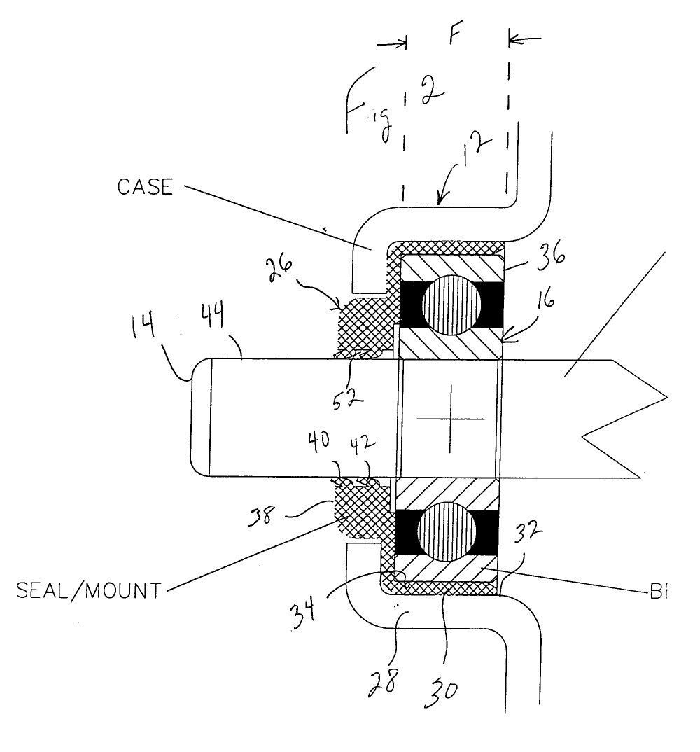

As seen in FIG. 2, the casing 12 defines a bearing housing 28 to mount bearing 16. The combined mount and shaft seal 26 includes a first bearing mount portion 30 that is compressed between the interior surface 32 of the housing 28 and the outer surface 34 of the outer race 36 of the bearing 16 to mount the bearing 16 in the housing 28 and create a seal therebetween. The uncompressed thickness of the first bearing mount portion 30 is selected to be sufficiently greater than the gap between the interior surface 32 and the outer surface 34 to provide a satisfactory seal when it is compressed between the surfaces 32 and 34. The actual uncompressed thickness depends on the type of material that forms combined mount and shaft seal 26, the temperature range to which the seal is exposed and other factors. The combined mount and shaft seal 26 also has a second shaft seal portion 38 with two sealing lips 40 and 42 that seal against the exterior 44 of the motor shaft 14. The combined mount and shaft seal 26 thus provides seals against the shaft 14, bearing 16 and housing 28 to prevent contaminants from entering the motor 10.

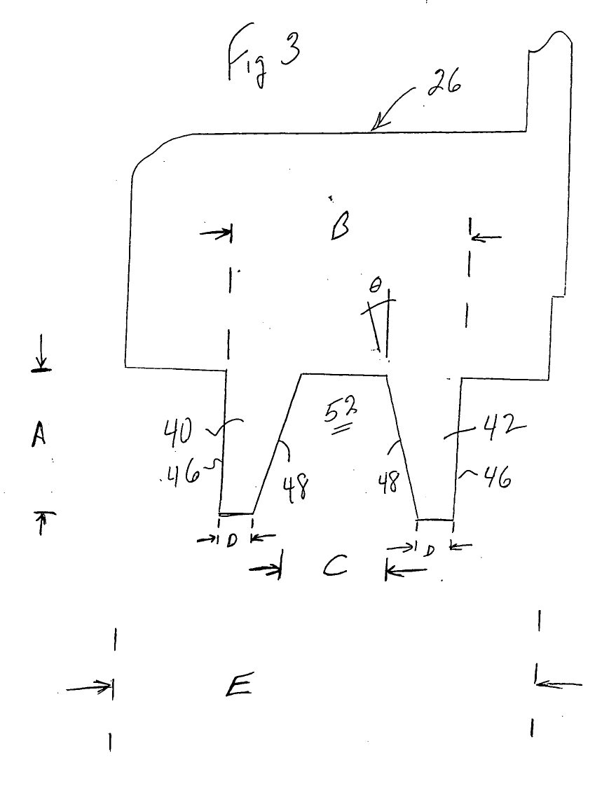

FIG. 3 illustrates the preferred shape of the lip seals 40 and 42. The seal lips 40 and 42 have an outer radial surface 46 that extends perpendicular the rotational axis 50 of the motor shaft 14 prior to engaging the shaft 14 and an inner tapered surface 48 that extends at an angle theta, between about 5 degrees and about 45 degrees, and preferably about 15 degrees or about 30 degrees, relative the rotational axis 50 prior to engaging the shaft 14. The shaft 14 is preferably inserted into the combined mount and shaft seal 26 from the interior 24 of the motor 10 (from right to left as seen in FIGS. 1 and 2) which causes the seal lips 40 and 42 to slant toward the exterior of the motor 10(to the left as seen in FIGS. 1 and 2). Thus, seal lip 40 seals against the shaft 14 with the inner tapered surface 48 thereof while seal lip 42 seals against the shaft 14 with the outer radial surface 46 thereof. This enhances the total seal against the shaft 14.

With the seal lips 40 and 42 slanting toward the exterior of the motor 10, if the air within the motor 10 is at a higher pressure than the exterior environment, the air can move past the seal lips 40 and 42 to the exterior environment to relieve the pressure in the interior 24. Air within the interior 24 can be at a higher relative pressure due to heat generated by the motor 10, changes in elevation, a source of vacuum, etc. However, the outward slant of the seal lips 40 and 42 prevents contaminants from the exterior environment from entering the interior 24 if the pressure in the interior 24 is less than the exterior environment as the pressure differential simply acts to increase the effectiveness of the seal between the seal lips 40 and 42 and the shaft 14. This keeps contaminants out of the motor. Contaminants can be air, water, oil or any other liquids or solids The pressure within the interior 24 can be less than the exterior environment due to cooling of the motor, water submersion, a vacuum source or changes in elevation, etc.

The seal lips 40 and 42 define a reservoir 52 therebetween. This reservoir can be filled with a synthetic grease or other lubricant to enhance the reliability of the motor 10.

While the combined mount and shaft seal 26 is preferably used on fractional horsepower motors 10, and in particular on D.C. permanent magnet fractional horsepower motors, it can be used on wound field motors, non-fractional horsepower motors and, indeed, on any type of unit, such as a pump, etc., with a bearing and shaft that must be supported and sealed in a housing.

A significant advantage of the combined mount and shaft seal 26 is that it is made of a unitary elastomeric member. However, if desired, the combined mount and shaft seal 26 could be made of separate components. The combined mount and shaft seal 26 can be made of any suitable elastomeric material, such as EPDM rubber, Teflon, PVC, natural rubber, SBR, GRS, butyl, EPR, EPT, nitrile(NPR), hydrin, neophrene, hypalon, urethanes, fluorsilicons, fluoroelastomers, polyurethanes, polysulfides, and silicones. The elastomeric material used preferably would have a durometer between 20 and 100 on the Shore A scale.

While two seal lips 40 and 42 are shown, the combined mount and shaft seal 26 can have one seal lip, or three or more seal lips. The seal lips can have other configurations than that shown.

In one application using the teachings of the present invention, the motor shaft 14 had an outer diameter of 8 mm or 0.3150 inches in one instance and an outer diameter of b 5/16 inches or 0.3125 inches in another instance. The interior surface 32 of the housing 28 was 0.938 inches in diameter and had a depth of 0.4 inches. The outer surface 34 of the outer race 36 had a diameter of 0.866 inches. The dimension A was 0.050 inches. The dimension B was 0.098 inches. The dimension C was 0.041 inches. The dimension D was 0.015 inches. The diameter of the opening through the combined mount and shaft seal 26 before deflection of seal lips 40 and 42 was 0.295 inches. The width E was 0.161 inches. The width F was 0.275 inches. The combined mount and shaft seal 26 was of EPDM Rubber with 85 durometer.

Another advantage of the combined mount and shaft seal 26 is the assistance provided by the combined mount and shaft seal 26 in alignment of the motor shaft 14. Because of the elasticity of the combined mount and shaft seal 26, minor misalignments of the shaft within the motor casing 12 can be accommodated.

Although only one embodiment of the present invention has been illustrated in the accompanying drawings and described in the foregoing Detailed Description, it will be understood that the invention is not limited to the embodiment disclosed, but is capable of numerous rearrangements, modifications and substitutions of parts and elements without departing from the scope and spirit of the invention.

1. A device for use with a housing and a shaft mounting a bearing thereon, with the shaft extending through the housing, the bearing having an outer race, the device comprising:
a unitary elastomeric member having a first portion mounting the outer race of the bearing in the housing and forming a seal between the bearing and the housing and a second portion sealing against the shaft.

2. The device of claim 1 wherein the housing is a housing for a fractional horsepower motor and the shaft is the motor shaft thereof.

3. The device of claim 1 wherein the unitary elastomeric member is of a material selected from the group consisting of EPDM rubber, Teflon, PVC, natural rubber, SBR, GRS, butyl, EPR, EPT, nitrile(NPR), hydrin, neophrene, hypalon, urethanes, fluorsilicons, fluoroelastomers, polyurethanes, polysulfides, and silicones.

4. The device of claim 1 wherein the second portion has first and second seal lips.

5. The device of claim 4 wherein the outer sides of the first and second seal lips are perpendicular a rotational axis of the shaft and the inner sides of the first and second seal lips are slanted at an angle of between about 5 and about 45 degrees.

6. The device of claim 4 wherein the outer sides of the first and second seal lips are perpendicular a rotational axis of the shaft and the inner sides of the first and second seal lips are slanted at an angle of about 15 or about 30 degrees.

7. The device of claim 4 wherein the first and second seal lips are deflected in a first direction when sealed against the shaft.

8. The device of claim 7 wherein the housing is a housing of a motor, the motor having an interior, the first and second seal lips deflected in the first direction away from the interior, permitting air to flow past the seal lips from the interior and preventing contaminants from moving past the seal lips into the interior.

9. A motor, comprising:
a housing;
a motor shaft for rotation about a rotational axis;
a bearing mounted on the motor shaft and having an outer race;
a unitary elastomeric member having a first portion compressed between the housing and the outer race of the bearing to form a mount for the bearing and supporting the motor shaft and a second portion sealed to the motor shaft.

10. The device of claim 9 wherein the unitary elastomeric member is of a material selected from the group consisting of EPDM rubber, Teflon, PVC, natural rubber, SBR, GRS, butyl, EPR, EPT, nitrile(NPR), hydrin, neophrene, hypalon, urethanes, fluorsilicons, fluoroelastomers, polyurethanes, polysulfides, and silicones.

11. The device of claim 9 wherein the second portion has first and second seal lips.

12. The device of claim 11 wherein the outer sides of the first and second seal lips are perpendicular a rotational axis of the shaft and the inner sides of the first and second seal lips are slanted at an angle of between about 5 and 45 degrees.

13. The device of claim 11 wherein the outer sides of the first and second seal lips are perpendicular a rotational axis of the shaft and the inner sides of the first and second seal lips are slanted at an angle of about 15 or about 30 degrees.

14. The device of claim 11 wherein the first and second seal lips are deflected in a first direction when sealed against the shaft.

15. The device of claim 14 wherein the motor has an interior, the first and second seal lips deflected in the first direction away from the interior, permitting air to flow past the seal lips from the interior and preventing contaminants from moving past the seal lips into the interior.
